(19) United States
(12) Patent Application Publication
(10) Pub. No.: US 2008/0069967 A1
(43) Pub. Date: Mar. 20, 2008

(54) Axial Bearing

(76) Inventor: Bjorn Lind, Goteborg (SE)

Correspondence Address: SCHWEGMAN, LUNDBERG & WOESSNER, P.A., P.O. BOX 2938, MINNEAPOLIS, MN, 55402, US

(21) Appl. No.: 11/596,378

(22) PCT Filed: May 18, 2005
(86) PCT No.: PCT/SE05/00723

§ 371 Date: Nov. 14, 2006

(30) Foreign Application Priority Data
May 18, 2004 (SE) 0401277-9

(51) Int. Cl. B05B 5/04

(52) U.S. Cl. 427/484; 239/700

(57) ABSTRACT

Arrangement for painting spindles for coating a surface with paint particles, comprising a spindle shaft (4), which is driven by an electric motor and mounted in air bearings, and, fixed on this shaft, a means (8) delivering the particles, and which has an electric potential difference relative to the object to be coated, wherein the spindle shaft (4) is mounted in at least one radial bearing (6) and also two axial bearings (7) positioned on respective sides of the rotor (13) of the motor, which rotor constitutes the axial support of the axial bearings (7).

The present invention relates to an arrangement for a painting spindle of the type indicated in the precharacterizing clause of Patent claim 1. Here, painting spindle means above all a painting spindle for paint application, but this does not exclude the possibility of media other than paint being used in connection with the invention. For the sake of simplicity, the description of the invention will refer to a painting spindle.

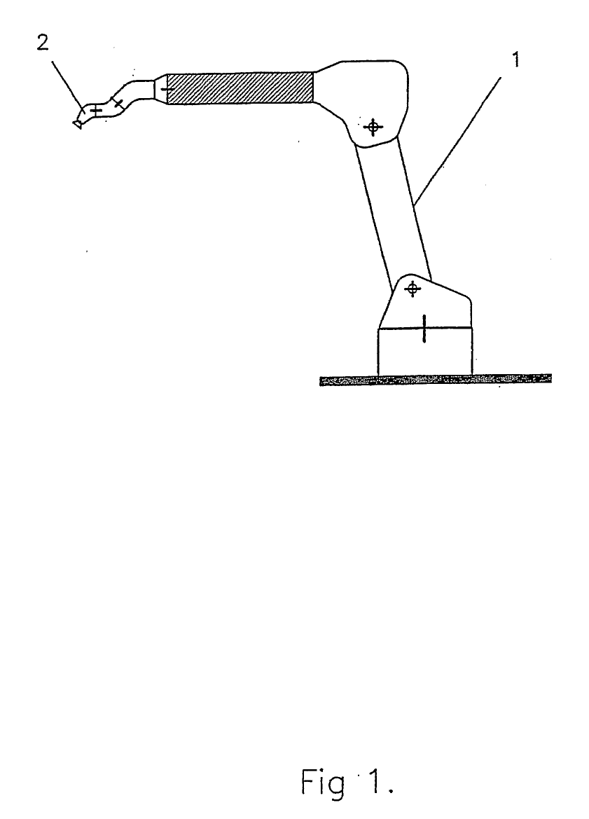

The most common area of application for such painting spindles today is the painting of car bodies, but the spindle can of course be used in many other cases where it may be considered suitable and possible. As far as the construction and functioning of the painting spindle are concerned, the spindle is mounted on a carrier means, usually as a tool in the hand of a robot (see FIG. 1) or in a portal, which can make it possible for the spindle to be moved relative to the object to be painted. In principle, the painting spindle consists, as the name indicates, of a spindle, at the driving end of which a conical outwardly directed bell is attached. The spindle shaft and with it the bell are rotated at between 6 000 and 130 000 rpm for example, and the opening of the bell can have a diameter of between 25 and 80 mm. Paint is fed through the spindle to the cone tip of the bell and will by virtue of the centrifugal force follow the inside of the bell out to its edge and there be thrown onward. In order to apply these paint droplets to the object, for example a car body, the paint particles are charged electrostatically and the object is earthed. The electrostatic charging potential relative to earth (object being painted) normally lies in the range of 30 000 to 130 000 volts. The paint particles which leave the bell are attracted by the object to be painted owing to the potential difference between the object and the paint particles. In order to deflect the charged paint particles, which will leave the bell in the radial direction owing to the rotation of the bell, a shaping airflow is supplied on the outside behind the bell, which airflow is essentially axially directed and thus forces the paint particle flow to be deflected towards the object from the bell. The electrostatic charging is usually brought about by the spindle being charged electrostatically, which means that the paint particles also become charged. Alternatively, the paint particles can be charged, after having left the bell, via rod antennas arranged, for example, in a circle around the part through which the paint particles pass on their way to the object to be painted. In order that the paint particles will be attracted by the earthed object to be painted, all other objects located in the vicinity of the charged paint particles must have the same potential as these. This means that, for example, the spindle and its attachment, the robot hand for example, have the same potential as the paint particles, which in turn means that an electrically insulating part must be present between the spindle and its attachment and the rest of the equipment in order to maintain the potential difference between the painting spindle and the object to be painted.

Owing to shaft diameter, rotational speed and requirements for cleanness, air bearings are the predominant bearing technology today. An electric eliminator, which is normally positioned at the rear edge of the spindle or directly behind the painting bell, is used in order to eliminate potential difference between the shaft and the spindle housing and also to prevent damage which can occur in the bearing surfaces owing to spark formation. In order to drive the spindle shaft, use is today made of an air turbine for the high speeds which are required. This makes it possible for the requisite energy in the form of compressed air to be transmitted to the electrically charged spindle unit without the requirement for electrical insulation being affected. With increasing capacity requirements (500-2000 cc/min paint), a greater energy supply to the turbine is required, which for practical reasons is normally brought about by increasing the pressure drop in the turbine. One effect of this is that the expansion of the air in the turbine gives rise to a fall in temperature, which results in the temperature of the spindle housing falling, which leads to the risk of the moisture in the surrounding air condensing against cold surfaces, which condensation can have a negative effect on the painting result. In some cases, the fall in temperature can even lead to ice formation in and in the vicinity of the turbine, which can jeopardize its performance and functioning. In order to reduce these cooling problems of the spindle, the air supplied is today often preheated, so that essentially a desired temperature can be obtained and ice and condensation problems are avoided. A further problem associated with the use of air in addition to the risk of condensation and ice formation is low efficiency with regard to energy supplied and the energy which the paint ultimately receives.

Against the background of the problems associated with painting spindles driven by air turbine, attempts have been made instead to drive such spindles with an electric motor. A painting spindle of the kind referred to here is normally arranged at the outer end of a robot arm, which means that the painting spindle has to be made as small and light as possible in order to increase access and usability during painting. The painting spindle must moreover be easy to mount, maintain and handle.

As mentioned above, the painting spindle is usually mounted as a tool in the hand of a robot. Owing to torque forces which arise in the robot arm, efforts are made to make the painting spindle as light as possible. In the case of a painting spindle driven by an electric motor, the dimensions of the electric motor are given for intended power, for which reason, in order to reduce the weight of the painting spindle, the spindle shaft is made as short as possible, thus reducing the total weight of the painting spindle. This is possible by virtue of the invention having been provided with the features indicated in the patent claim.

The present invention aims to solve this problem, which is possible by virtue of the invention having been provided with the feature indicated in patent claim 1.

For the purpose of clarification, a painting spindle will be described in its entirety in greater detail below with reference to the drawing, in which:

FIG. 1 shows diagrammatically a robot, bearing a painting spindle at the end of its outer robot arm;

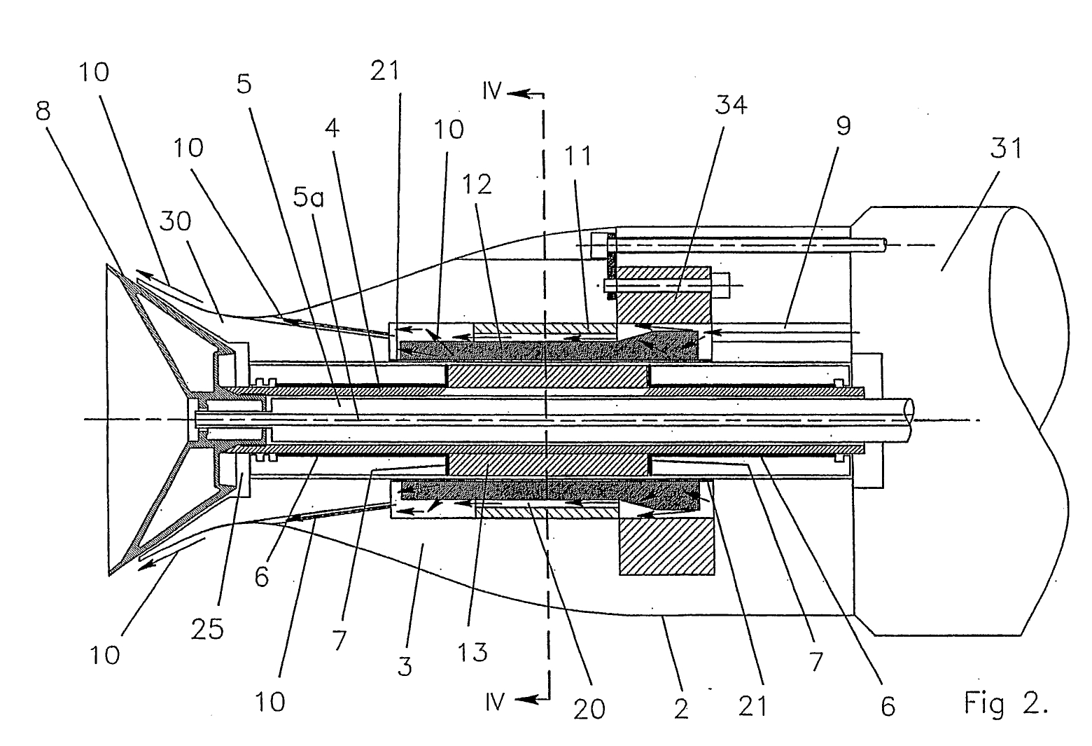

FIG. 2 shows a diagrammatic section through a painting spindle according to the invention;

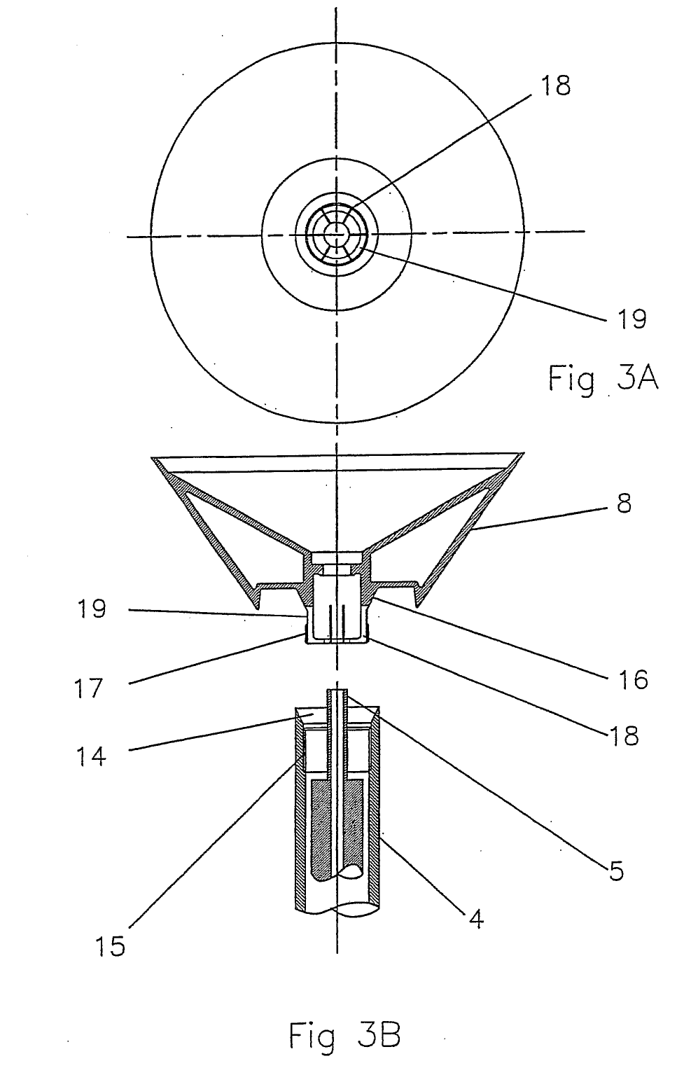

FIG. 3A shows a painting bell seen from its side adjoining the shaft and FIG. 3B shows a longitudinal section through the painting bell and the spindle shaft, separated from one another;

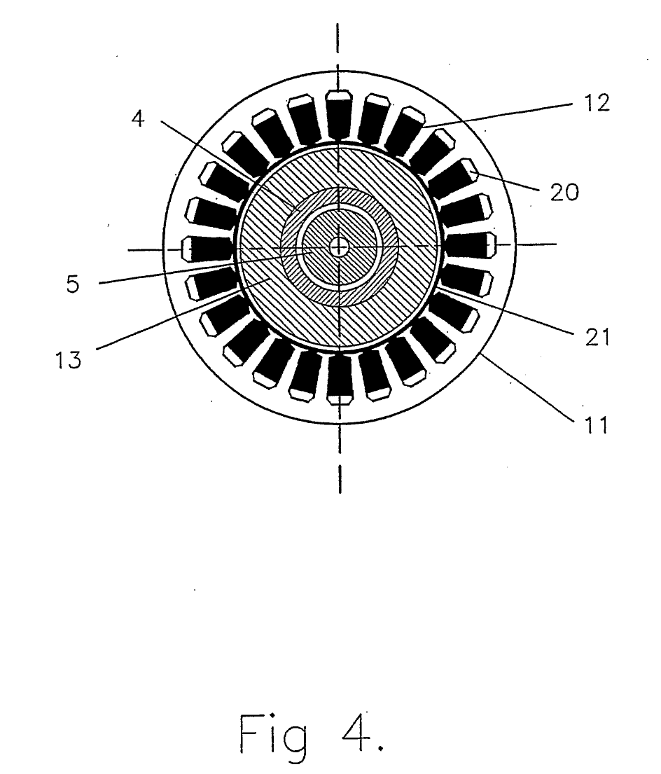

FIG. 4 shows a section along the line IV-IV in FIG. 2, but only of the rotor and stator;

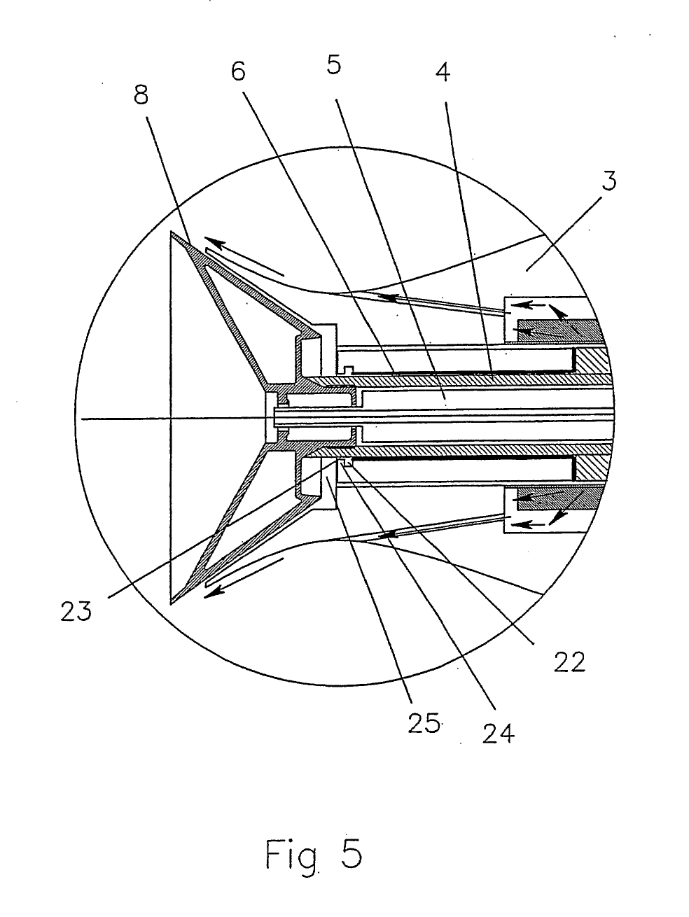

FIGS. 5 show two different embodiments of one and 6 housing end of the painting spindle;

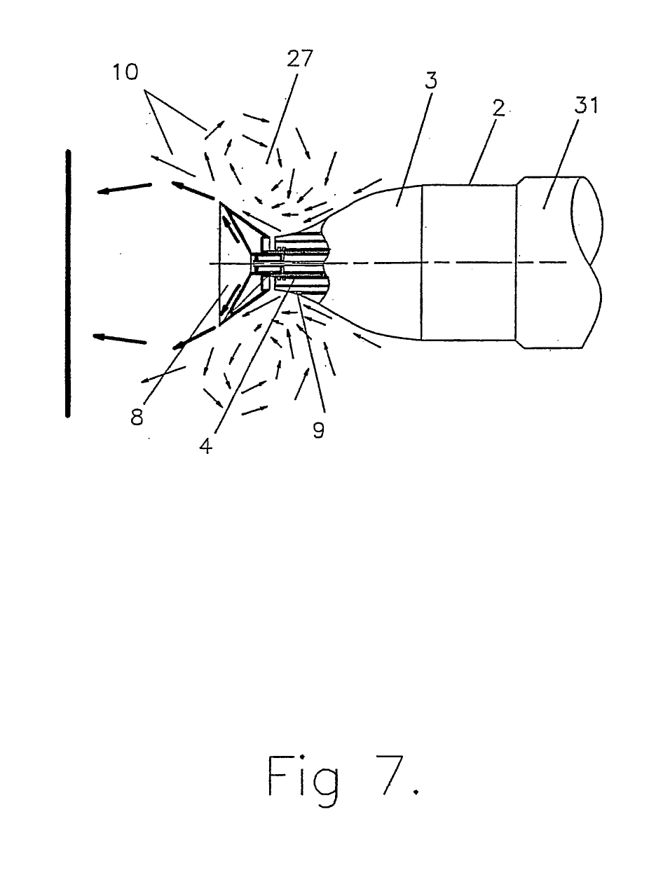

FIG. 7 shows diagrammatically air turbulence outside the painting spindle during its use;

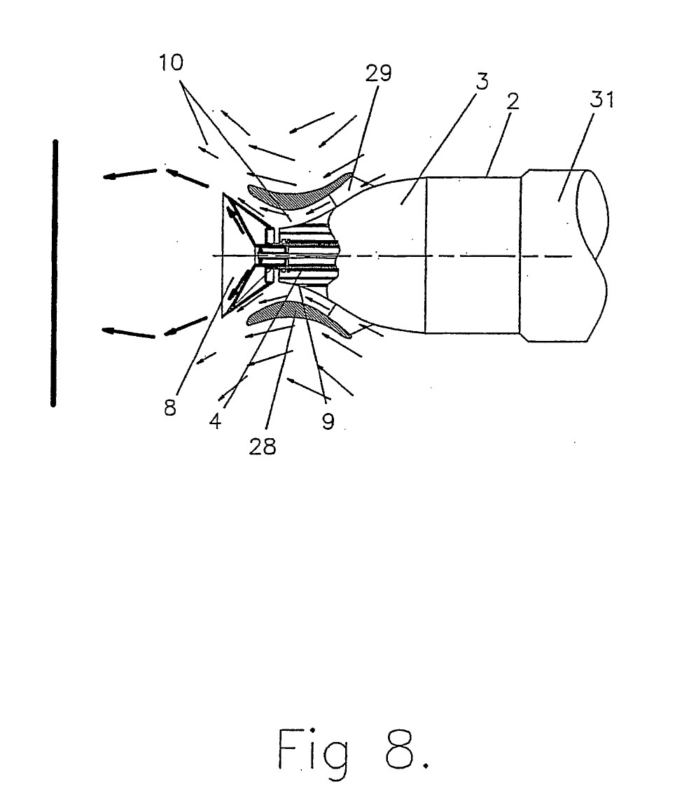

FIG. 8 shows a design for moderating the turbulence;

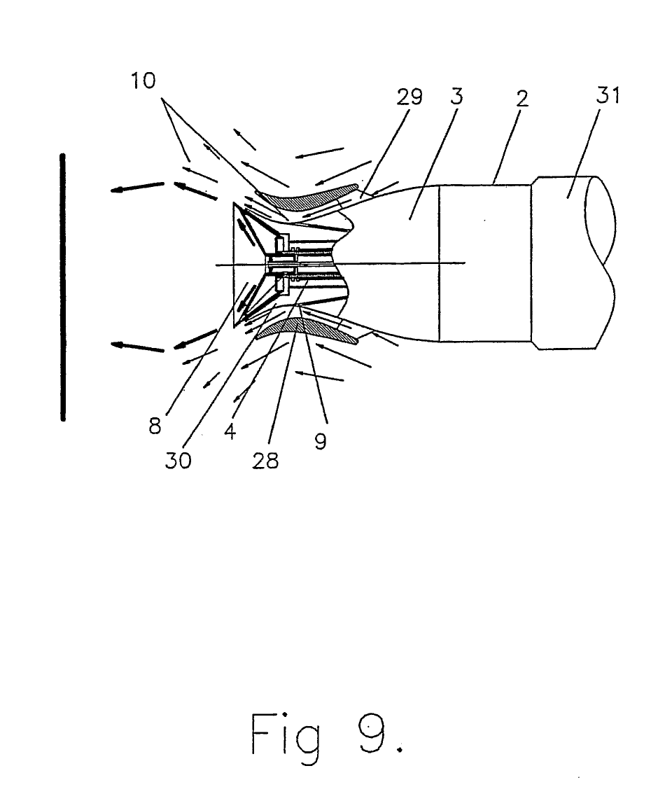

FIG. 9 shows another design for moderating the turbulence;

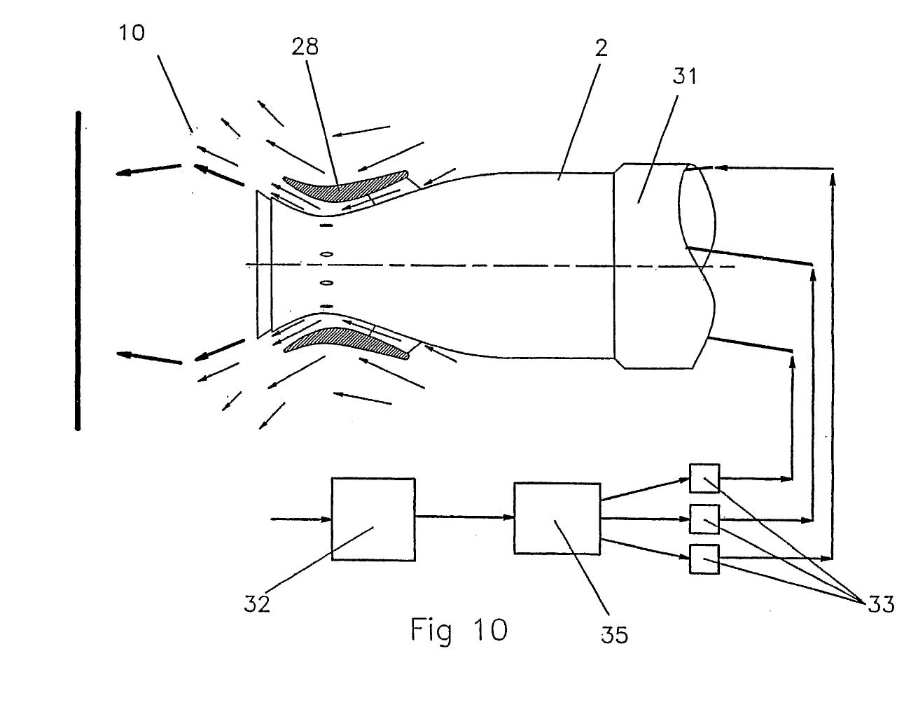

FIG. 10 shows diagrammatically the transmission of the requisite energy and control information to the painting spindle;

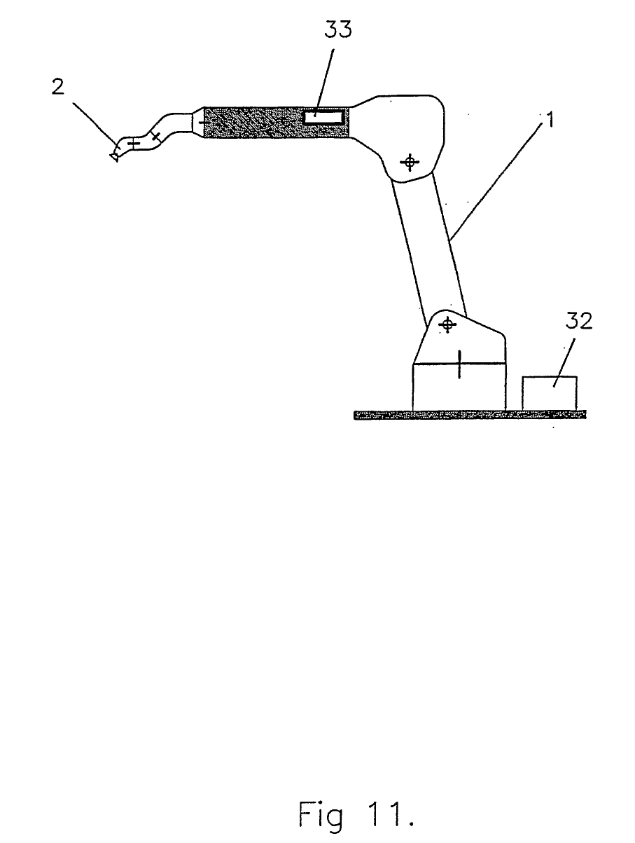

FIG. 11 shows an example of the positioning of a safety transformer;

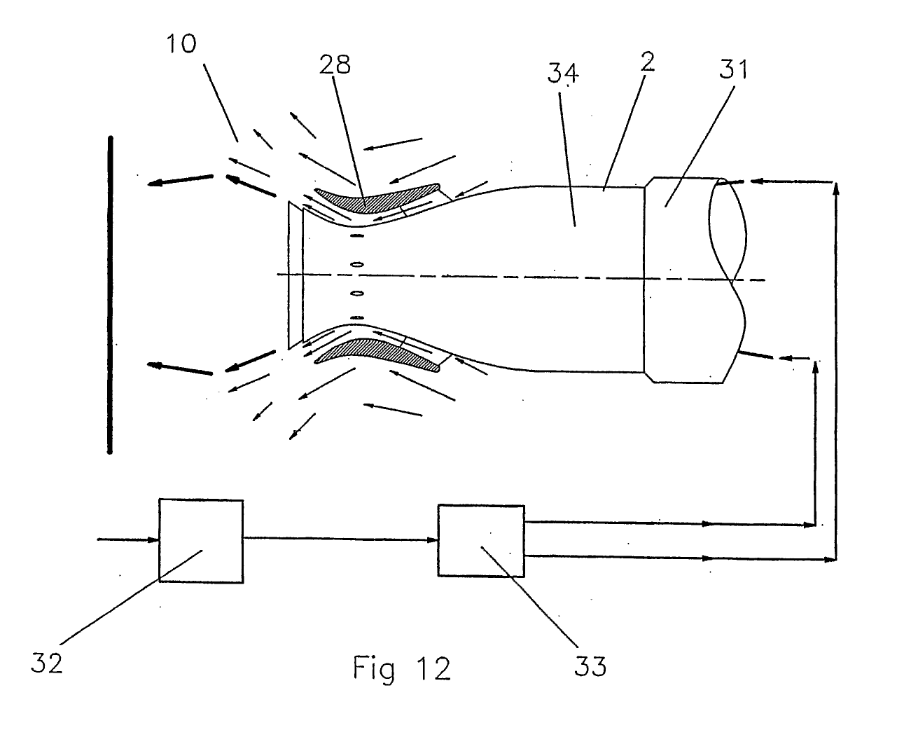

FIG. 12 shows diagrammatically another design of the transmission of energy and control information to the painting spindle;

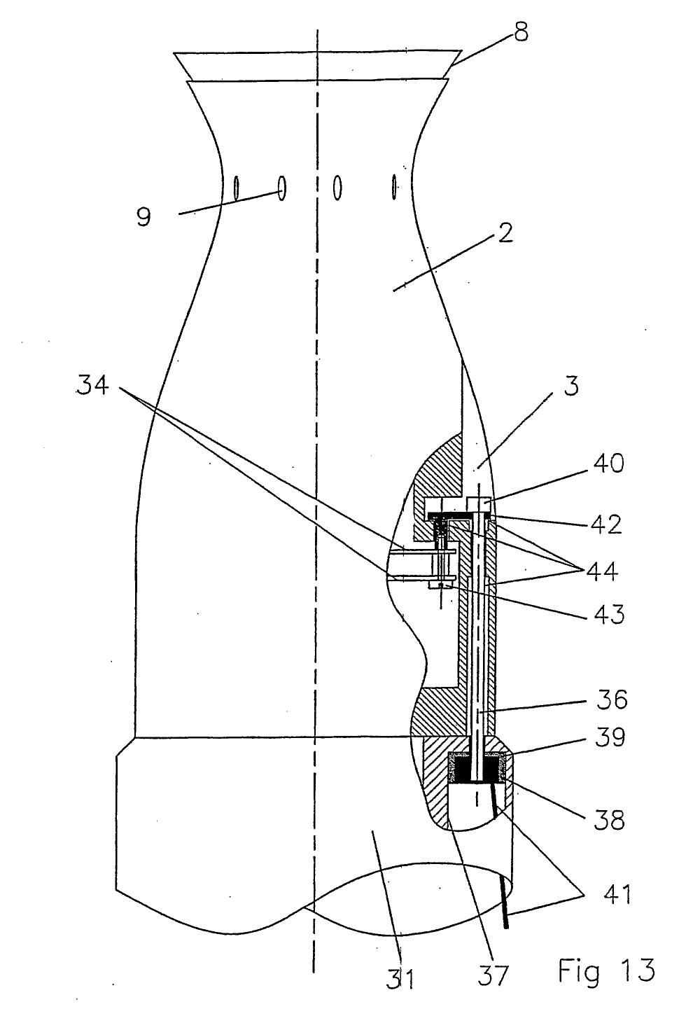

FIG. 13 shows a combined mounting bolt and electricity connection;

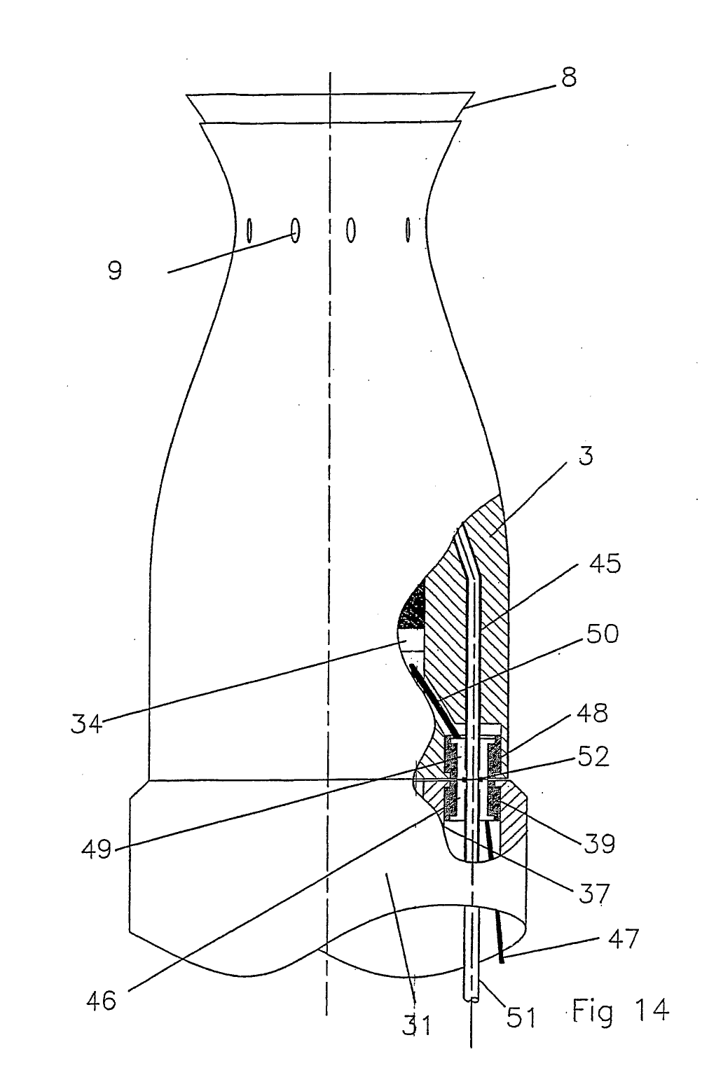

FIG. 14 shows a combined air connection and electricity connection;

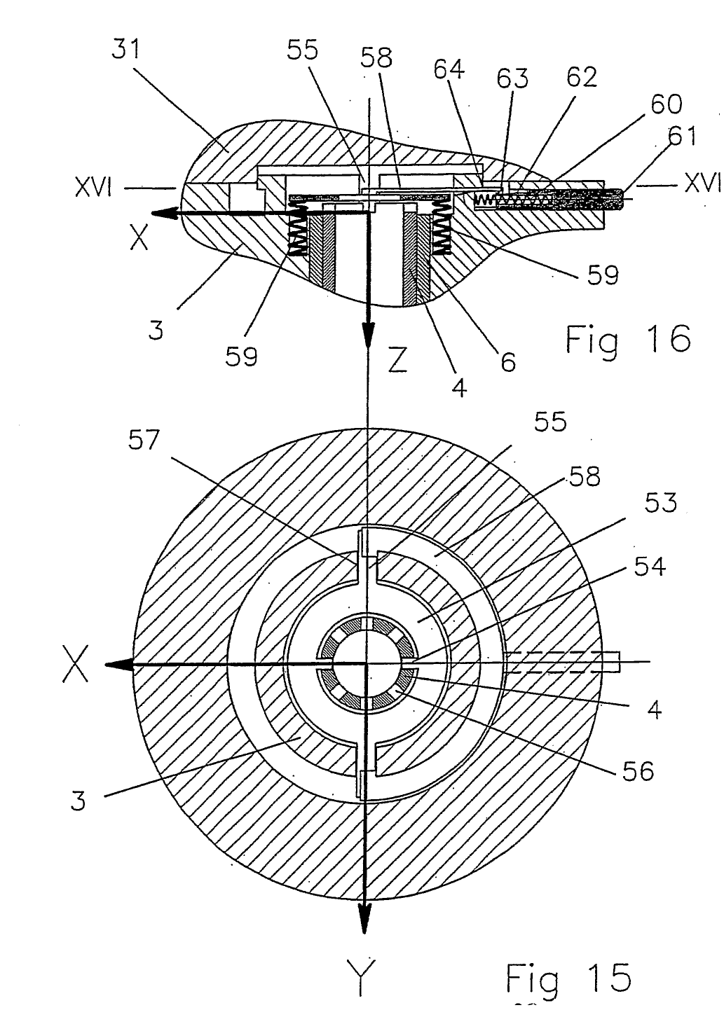

FIG. 15 shows diagrammatically a cross section through the painting spindle just outside one end of the spindle shaft, and

FIGS. 16 show two different positions of a and 17 rotational fixing means of the spindle shaft.

FIG. 1 shows diagrammatically a robot 1 with a painting spindle 2 mounted at the outer end of the outer robot arm, as is the known art today.

In FIGS. 2, 3 designates the spindle housing for a painting spindle, accommodating a rotating shaft 4, which in turn accommodates a non-rotating tube 5. The rotating shaft 4 is mounted in the housing 3 by means of two radial air bearings 6 and, in the example shown, two axial air bearings 7 and bears at one end, the left end in the figure, a frustoconical funnel 8, what is known as a painting bell, which rotates together with the shaft 4. The stationary tube 5, which via a duct 5 a conducts paint towards the funnel 8, opens at the end of the rotating shaft 4 and inside the bell 8, as can be seen from the figure. Today, the shaft 4 normally rotates at between 6 000 and 130 000 rpm. 9 designates air ducts arranged in the spindle housing, which generate a shaping airflow 10, which causes the paint particles thrown out of the bell 8 during its rotation to deviate in the axial direction towards the object (not shown) to be painted. The object has earth potential and the spindle with the paint particles has a voltage potential relative to the object, lying in the range of 30 000 to 130 000 volts, which means that the paint particles are attracted by the object to be painted. The shaft 4 is driven by an electric motor consisting of stator iron 11, stator winding 12 and a rotor 13 fixed to the shaft 4. What has been described so far belongs to the known art and should therefore not require further explanation.

Apart from mains connection via a safety transformer, which creates the necessary electrical separation between the different potential levels (30 000 to 130 000 volts), it is also possible to use energy-storing or energy-generating units such as, for example, batteries, capacitors or fuel cells, electrically separated from the object to be painted, as the energy source for the electric motor.

Mounting of the Painting Bell on the Spindle Shaft

FIG. 3B shows in section the rotating spindle shaft 4 with the paint tube 5 fixed therein. 14 designates a part-cone-shaped surface of the spindle shaft 4, and 15 designates an internal thread of the shaft. The painting bell 8 also has a part-cone-shaped surface 16, which interacts with the part-cone-shaped surface 14, and an external thread 17, which interacts with the thread 15 of the spindle shaft.

In order to prevent the painting bell 8 accidentally coming loose from the spindle shaft 4 at high rotational speeds, the threaded part 17 of the painting bell 8 has in accordance with the present invention been provided with axial slots 18 forming segments 19, six segments in the case shown. This means that, when the painting bell is screwed firmly onto the shaft 4, the threaded segments 19 of the bell 8 will yield radially inwards against the threads and the thread flanks on the threaded part 15 of the shaft 4, which means that, when the shaft 4 rotates, the segments 19 will on account of the centrifugal force be forced outwards or expand and the segments 19 of the painting bell 8 will generate a radially outwardly directed force, which is in turn transmitted to the thread flanks interacting between the spindle shaft 4 and the bell 8, which also means that an axial force is produced which causes the part-cone-shaped surfaces 14 and 16 to “lock” on one another.

The expansion owing to the centrifugal force on the threaded segments 19 will thus lock the painting bell 8 firmly on the shaft 4 and prevent the painting bell 8 coming loose during operation. The resilient properties of the threaded segments 19 will also ensure that the painting bell 8 is guided into locked position by the cone 16 and 14 and not by the threads 15, 17, which reduces the tolerance requirements between the respective cone and thread of both the painting bell 8 and the spindle shaft 4.

Cooling of the Stator

When an electric motor 11, 12, 13 (see FIG. 2) is used as the drive source for the spindle shaft 4, heat loss arises in the stator iron 11, stator winding 12 and rotor 13 of the motor in addition to the heat produced by the friction losses. So as not to risk the functioning of the spindle shaft 4, for example owing to excessive heating and thus expansion which cannot be handled, it is necessary to dissipate a sufficiently large part of the heat loss arising, that is to cool the spindle 4.

This takes place by the excess heat being carried off with the aid of the compressed air intended for the shaping airflow 10 and supplied to the arrangement. This compressed air, or at least part of it, is introduced according to the example shown in FIG. 2 through one or more ducts 9 in the housing 3 in contact with the stator winding 12 of the electric motor. The figure shows with the aid of arrows the compressed air passing through the stator winding 12 in ducts 20 next to this.

FIG. 4 shows a cross section IV-IV through the stator in FIG. 2, in which the windings of the latter are designated by 12. These windings are provided with adjacent through-ducts 20 for the passage of the compressed air (the shaping air) through the stator and are arranged, according to this figure, on that side of the windings which faces away from the rotor 13; ducts 20 can of course be positioned on the inside of the winding or between the winding wires in the respective winding grooves in the stator. In this way, effective cooling of the stator and also partial cooling of the rotor are achieved. However, in order that the cooling air does not leak out to the gap between the rotor and the stator, the stator is covered by a leakage-preventing lining 21 (see FIGS. 2 and 4).

The shaping airflow 10 leaves the ducts 20 in the stator 11 between its winding ends, indicated by the arrows at the ends of the stator winding 12 in FIG. 2.

Rotational Fixing of the Spindle Shaft in Relation to the Spindle Housing without Undefined Radial Loads Arising

One problem is demounting (or mounting) the painting bell 8 (see FIGS. 2, 15-17) from (on) the spindle shaft 4 without damaging the bearings 6 of the latter in the spindle housing 3. The bell 8 is normally screwed onto the spindle shaft 4, for which reason a torque is required for demounting and mounting the bell, which means that a counter-torque must be applied to the spindle shaft. This counter-torque is brought about today by virtue of a torque arm—a pin—being provided in the spindle shaft, normally at its end facing away from the bell, which pin is used manually or with the aid of a stop as a stay. This means that, when the torque for demounting and mounting is applied, the spindle shaft 4 will be subjected to a radial force during this work, which leads to the spindle shaft 4 being supported in an uncontrolled way against the bearing surfaces with uncontrolled bearing loads, which can thus cause damage to the bearings.

FIGS. 15-17 show an arrangement where the bearing surfaces will not be radially loaded in an uncontrolled way by the spindle shaft 4 when the torque for demounting or mounting the bell 8 is applied, as the arrangement is designed in such a way that the counter-torque is transmitted to the spindle housing 3 with free translation of the spindle shaft 4 in the radial plane X-Y being allowed but rotation of the spindle shaft 4 relative to the spindle housing 3 being prevented.

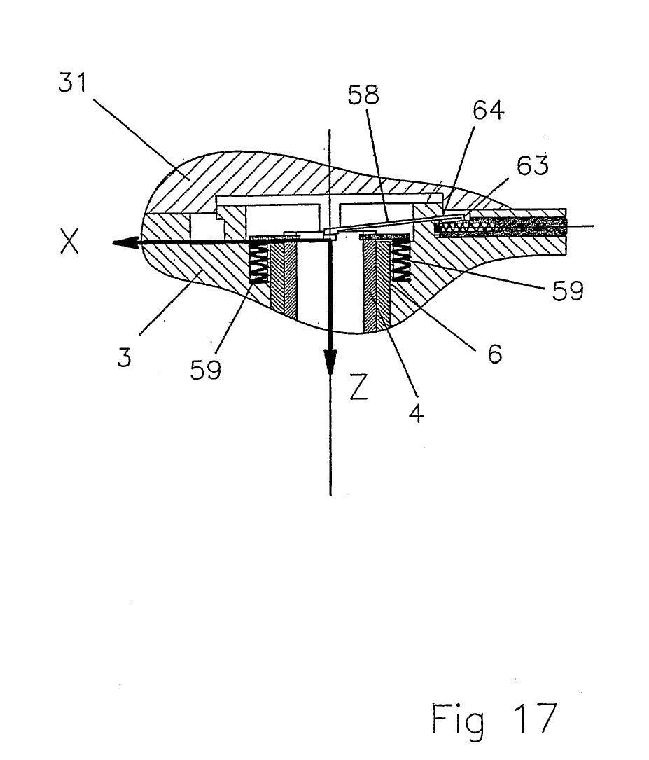

The said arrangement comprises a locking washer 53 in the form of a ring, the inside diameter of which is slightly larger than the outside diameter of the spindle shaft 4. The locking washer 53 is provided with a first pair of inner, diametrally opposite driving pins 54 and also a pair of second driving pins 55 directed outwardly diametrally in relation to one another, which are arranged at right angles to the driving pins 54. The end of the spindle shaft 4 is provided with a number of grooves 56 (eight grooves are provided in the example shown in the figure). The grooves 56 are dimensioned in such a way that they can accommodate the driving pins 54, while the second driving pins 55 are accommodated in grooves 57 in the spindle housing 3. The locking washer 53 is limitedly movable in the axial direction in relation to the spindle shaft 4 in such a away that the driving pins 54 can be brought into and out of engagement in the grooves 56 while the driving pins 55 are displaced in the grooves 57 (cf. FIGS. 16 and 17). Arranged axially outside the locking washer 53 is a yoke 58 extending in a semicircular shape (for clarity, the yoke 58 is not sectioned in FIGS. 16 and 17), which is likewise limitedly movable in the axial direction. The free ends of the yoke 58 engage on the outside of the locking washer 53 and, according to the example shown, on top of the second driving pins 55. With the aid of the yoke 58, the locking washer 53 can thus be moved axially between a position (see FIG. 16) in which the locking washer 53 is, by springs 59 recessed in the spindle housing 3, held displaced in such a way that the driving pins 54 are out of engagement with the spindle shaft and a second position (see FIG. 17) in which the locking washer 53 is, counter to the action of the springs 59, held pressed down with the driving pins 54 and 55 in engagement with the grooves 56 of the spindle shaft and respectively the grooves 57 of the spindle housing 3. The yoke 58 is operated with the aid of an operating means 61, which can be displaced axially counter to a spring 60. The operating means 61 is provided with an inclined or wedge-shaped surface 62, which engages under the yoke 58, suitably under a heel 63 indicated in FIGS. 16 and 17. When the operating means 61 is held by the spring 60 in the guided-out position according to FIG. 16, the locking washer 53 is guided out by the springs 59 into the position in which the driving pins are free of the grooves in the spindle shaft. By pressing the operating means 61 in counter to the force of the spring 60, the heel 63 will be pressed upwards at the same time as the yoke 58 pivots around a stay 64 of the spindle housing, which stay leads to the yoke 58 acting as a lever, with the fulcrum in the stay 64, and thus pressing the locking washer 53 down, so that the driving pins 54 engage in the grooves 56. The spindle shaft is thus prevented from rotating relative to the spindle housing but can move freely in the radial direction. If the operating means 61 is released, this is pushed out, and the yoke with the locking washer 53 is guided by the force of the springs 59 out of engagement with the said grooves. The outwardly directed movement of the operating means 61 is of course limited in a suitable way.

Protecting the Outlet of Radial Bearings from being Contaminated by Paint

A major problem today is that paint accumulates on the spindle shaft 4 (see FIGS. 2, 5, 6) at one or both radial air bearings 6, 6. After a time, this results in the air acting in the radial bearing being prevented from freely leaving the bearing gap, which has a negative effect on the loading capacity of the bearing and also cooling, reducing the functioning and life of the painting spindle 2 in a decisive way.

In order to prevent this accumulation of paint on the spindle shaft 4, which disrupts the functioning of the front and/or rear radial air bearings 6, a chamber 22 is arranged immediately outside the bearing or bearings and adjacent to the bearing gap, which chamber runs all around and is open with a gap 23 towards the spindle shaft 4. The bearing air, which operates with positive pressure and leaves the bearing gap and flows into the chamber 22, forms a certain positive pressure therein, which leads to a small part of the bearing air acting as barrier air and flowing out into the gap between the spindle shaft 4 and the lip running around it between the chamber 22 and a space 25, preventing paint from entering the chamber, while the greater part of the bearing air is carried off from the chamber in a conventional way (not shown), which avoids a detrimental counterpressure arising in the bearings.

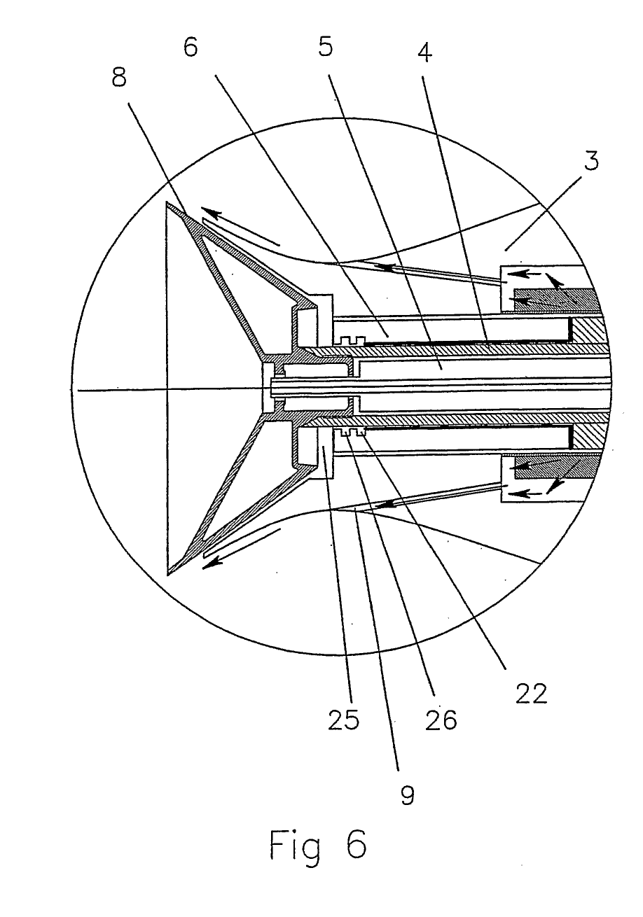

It is also conceivable to arrange an additional, second chamber 26 outside the chamber 22 shown, as illustrated in FIG. 6. Protective air is supplied to the chamber 26 with a positive pressure. This protective air is drained on the one hand to the chamber 22 and on the other hand to the space 25 (duct for air supply of protective air to the chamber 26 is not shown).

In the embodiment where the spindle housing is extended and surrounds the painting bell and a gap is formed between the outer periphery of the painting bell and the spindle housing (see FIG. 6), separate extra ducts (not shown) can lead to the space 25 in order for it to be possible to bring about a desired pressure in the space 25.

Surface Treatment of the Spindle Shaft

A different way from that described above, or a complement to it, for preventing paint adhering and accumulating on the spindle shaft 4 (see FIG. 2) adjacent to one or both radial air bearings 6 is for the spindle shaft 4 to be coated at least on part of its axial extent with a surface coating, which reduces the possibility of the paint adhering to the spindle shaft; otherwise, the outflow of the bearing air from the bearings 6 is affected, which reduces the loading capacity of the bearings and also their cooling.

An example of a surface coating is Teflon®.

Controlling the Shaping Airflow (FIGS. 7, 8 and 9)

As mentioned above, the shaping airflow 10 is supplied at high speed essentially axially towards the painting bell 8 in order, in interaction with the electrostatic force, to deflect the paint particles thrown out by the bell towards the object to be painted. The function of the shaping airflow 10 of deflecting the paint particles towards the object is not entirely effective, but a certain turbulence occurs outside the bell 8 when the shaping air flows out on its outside and draws the surrounding air along with it, a turbulence which has a tendency to draw paint particles along with it as well, which can then settle on the outside of the arrangement. This is indicated by arrows 27 in FIG. 7.

In order to prevent this inconvenience, which occurs in today's painting spindles, a guide vane means 28 (FIGS. 8 and 9) is provided, which extends on the outside of the painting spindle 2 and adjacent to the bell 8 and the outlets 9 of the shaping air 10 (cf. FIG. 6 also) from the arrangement. The guide vane means, which is shown as an example in FIG. 8, guides the surrounding air drawn along by the shaping air 10 in an essentially laminar airflow over the bell 8, by virtue of which the turbulence 27 (FIG. 7) adjacent to the outside of the bell 8 is moderated or eliminated. The guide vane means 28 can have the shape of a “ring” running all around or be divided into a number of sections. 29 designates support flanges for the guide vane means 28, which can suitably be two or more in number. The guide vane means 28 with its support flanges 29 is mounted on and demounted from the spindle housing 3 in the axial direction, the support flanges 29 being snapped firmly on the spindle housing 3 in the recesses which are present in connection with the mounting screws (not shown) of the spindle.

FIG. 9 shows an embodiment where a filler 30 is arranged as an integrated extension of the spindle housing 3 extending over the periphery of the bell 8, by virtue of which a more even flow of the air drawn along by the shaping airflow is obtained at the transition from housing to bell in comparison with the embodiment according to FIG. 8.

In the figures, 31 designates an attachment for the painting spindle. The filler 30 has an outer form which is suitably shaped to follow the inside of the guide vane means 28.

Arrangement of Axial Air Bearings According to the Invention

In order to achieve a painting spindle and thus painting equipment which is as short and compact as possible, which is of great importance for facilitating its use, the positioning of the usually two axial air bearings is of great importance.

In this connection, an optimal solution is to arrange the two axial air bearings 7 (see FIG. 2) on respective sides of and adjacent to the rotor 13 on the spindle shaft 4. At the same time as the installation of the axial bearings 7 is compact, the rotor will offer a natural support for the axial air bearings in the axial direction. Special installation measures for the axial air bearings, which extend the spindle shaft 4, are not necessary.

Use can be made of single-acting axial bearings, where the axial force in the opposite direction is brought about by a magnetic field (embodiment not shown). When the axial air bearing is not functioning, the surface against which the shaft is pressed by the magnetic field can be used as a friction surface in order to brake the rotation of the spindle shaft.

Coding of Painting Spindle

The practice of using pirate components together with an original product is becoming increasingly common. This is dangerous in some cases and can have devastating consequences if the pirate component does not have the quality (dimensions, material selection etc.) which is required of an original product.

In order to prevent the use of a pirate-manufactured painting spindle 2 (see FIG. 2), for example in the event of exchanging an original spindle of an original arrangement according to the invention, it is proposed that the painting spindles manufactured are provided with a code, which is read by the control equipment of the arrangement and makes it possible for only a correctly coded painting spindle 2 to be used in the original arrangement. The absence of a code or an incorrect code leads to the control equipment of the painting spindle responding and making the arrangement unusable, for example by disconnecting the power supply of the electric motor.

By coding the painting spindle, it is also possible to track and collect data during operation of the arrangement and to obtain basic information from this data in order to be able to increase the reliability and performance of the product. This can take place, for example, by each individual painting spindle being identified via a control system included in the arrangement and data being sent to a spindle-monitoring system at the supplier's, in which way historical operating data for this individual spindle can be collected.

Speed Control of the Spindle (see FIGS. 10, 11, 12)

A painting spindle of the kind referred to here driven by an electric motor is normally carried at the outer end of the arm of a painting robot, as shown in FIG. 1. In view of the rapid movement sequence of the robot arm and associated torques and loads on the robot, efforts are made to minimize the weight of the painting spindle 2.

In FIG. 12, 32 designates a power source with alternating current, the frequency of which is variable. The alternating current fed from the power source 32 is conducted to a safety transformer 33, where the alternating current is converted to low-tension direct current, for example 40 V, which direct current will contain a superposed frequency which is proportional to the frequency with which the motor is to be speed-controlled. This frequency is detected by control electronics 34 (see also FIGS. 13, 14) integrated in the painting spindle, where the direct current is, using the superposed alternating voltage, converted to the desired feed frequency which causes the electric motor (11, 12, 13) of the painting spindle (see FIG. 2) to rotate at the desired speed.

The advantage of connecting the safety transformer 33 to the power supply before the control unit 34 is that the safety transformer 33 can be allowed to operate at a considerably higher frequency than that desired for the motor. This in turn means that the transformer can be made compact, that is with smaller volume and lower weight, as it is desirable, as can be seen from FIG. 11, to position the safety transformer 33 in the robot arm. It is of course also possible to combine the transformer 33 and the control unit 34 to form a single unit if so desired.

Information exchange between the power source and the motor control, in order to bring about the desired operating characteristics, such as acceleration, deceleration and speed, takes place by communication with units connected to the primary or secondary side of the transformer via information transmitted via light, sound, radio communication or information in the energy transmitted or a combination thereof. The rotational speed can for example be read optically or via sound impulses, which can be used without the requirement for electrical insulation being affected.

The safety transformer 33 is suitably fed with an alternating voltage, the frequency of which is a multiple of the desired speed of the spindle shaft 4, for example 12-9 times the speed. By virtue of this, it is possible to minimize the physical size and weight of the transformer. The alternating voltage received in the control electronics (indicated by reference 34 in FIG. 12) is to have a frequency which is a factor lower than the frequency with which the safety transformer 33 is fed in order to constitute the desired frequency in order to drive the spindle shaft 4 at the desired speed. By varying the frequency of the alternating current fed from the power source 32 to the safety transformer 33, the speed of the spindle shaft 4 can thus be changed.

FIG. 10 shows diagrammatically a configuration which, in contrast to what is shown in FIG. 12, has the control electronics 35 and the power supply unit 32 positioned alongside the robot while the three safety transformers 33 are positioned in the robot arm and will in this embodiment operate with the desired frequency of the motor and thus be considerably heavier.

FIG. 12 shows an embodiment in which the control electronics 34 are built into the actual housing of the painting spindle 2. The power source 32 shown in the figure and the safety transformer 33 can of course be combined to form a unit.

Use of Connection Means for Electricity Connection

A painting spindle driven by an electric motor requires for its functioning both electricity connections for operation of the motor (usually 3-phase and thus three connections; in the case of control electronics integrated in the spindle, two connections are required for direct current) and connections for on the one hand cooling air and on the other hand shaping air. In addition, bolts are required for mounting the painting spindle at the end of a robot arm. In the case of three mounting bolts, it is therefore necessary for reconditioning or exchanging the painting spindle to handle three electricity connections, one cable for control information, two air connections and three bolt connections.

These eight mutually different connections involve unnecessarily time-consuming work in the demounting and mounting of the painting spindle from and on a robot arm. The intention is therefore to reduce the number of connections and to have the mounting bolts also serve as electricity connections or the air connections also serve as electricity connections or a combination where both mounting bolt and air connection can serve as an electricity connection at the same time.

FIG. 13 shows diagrammatically a painting spindle, which, by means of three mounting bolts 36 (only one shown) for example, is mounted on for example the end of a robot arm via a mounting flange 31 fixed to the arm. The mounting flange 31 is provided with a recess 37 for each bolt, in which recess 37 a bronze nut 38 is accommodated, which is electrically separated from the walls of the recess 37 and thus from the mounting flange 31 by means of an insulation 39. A mounting screw 36 supported with its head 40 in a shoulder of the housing 3 of the painting spindle extends in an insulated manner through the housing 3 and is screwed firmly into the bronze nut 38. An electricity cable 41 (one of the conductors) is electrically connected to the nut 38. In the drawing, 34 designates diagrammatically the control electronics of the motor, which receive their power in the example shown by means of an electrically conductive bridge 42, which is electrically insulated (indicated by reference designation 44 in FIG. 13) from the housing 3 of the painting spindle but which is electrically conductively secured on the one hand by the head 40 of the mounting bolt 36 and on the other hand by means of a screw 43, which in the example shown extends through the control electronics 34 and via a thread connection electrically conductively secures the bridge 42.

If the mounting bolts of the painting spindle 2 are designed in the way described here, it is easy to understand that mounting and demounting of the painting spindle on and from the mounting flange 31 are effected simply by merely undoing the bolts 36, as the air connections (not shown) consist of plane surfaces which close tightly when the spindle is mounted.

FIG. 14 shows how in a corresponding way an air connection also constitutes the electricity connection for the control electronics and motor of the painting spindle. The air line in the painting spindle is designated by 45. As described in connection with FIG. 13, the mounting flange 31 is provided with a recess 37 in this case as well. A first bush 39 is fitted in the recess 37. The bush 39 surrounds a first electrically conductive sleeve 46 and insulates it from the mounting flange. An electricity cable 47 is electrically connected to this sleeve 46.

In a corresponding way, a second insulating bush 48, which surrounds a second electrically conductive sleeve 49, which is electrically connected to the control electronics 34 or motor of the painting spindle by means of an electricity cable 50, is arranged in the housing 3 of the painting spindle.

The air line 45, like the air line 51 connected to the mounting flange 31, consists of electrically non-conductive hoses for example, which each extend partly into a hole passing through the bushes 46, 49, as can be seen from FIG. 14. Between the ends of the hoses 51 and 45 in the bushes 46 and 49, the through-hole of the bushes has a smaller diameter, which corresponds to the inside diameter of the hoses, and the bushes 46 and 49 themselves thus form a part of the air line. A sealing ring, which prevents air leakage, is arranged, around the hole formed, between the conductive contact surfaces of the bushes 46 and 49.

It can be seen from this that as soon as the painting spindle has been mounted on the mounting flange 31, simultaneous connection of the painting spindle to air and electricity is automatically achieved.

1. Arrangement for painting spindles for coating a surface with paint particles, comprising a spindle shaft (4), which is driven by an electric motor and mounted in air bearings, and, fixed on this shaft, a means (8) delivering the particles, and which has an electric potential difference relative to the object to be coated, characterized in that the spindle shaft (4) is mounted in at least one radial bearing (6) and also two axial bearings (7) positioned on respective sides of the rotor (13) of the motor, which rotor constitutes the axial support of the axial bearings (7).
